(19) United States
(12) Patent Application Publication
(10) Pub. No.: US 2011/0107429 A1
(43) Pub. Date: May 5, 2011

(54) SYSTEM AND METHOD FOR MANAGING ACCESSIBILITY TO REAL OR VIRTUAL OBJECTS IN DIFFERENT LOCATIONS

(76) Inventors: Emmanuel Marilly, Nozay (FR); Corinne Obled, Nozay (FR)

(21) Appl. No.: 12/935,996

(22) PCT Filed: Mar. 23, 2009
(86) PCT No.: PCT/FR2009/050491

§ 371 Date: Jan. 3, 2011

(30) Foreign Application Priority Data
Apr. 2, 2008 (FR) 0852157

(51) Int. Cl. G06F 21/00

(52) U.S. Cl. 726/26

(57) ABSTRACT

A system (S), dedicated to managing accessibility to objects in different locations (L1-L3), characterized in that it comprises i) distributed management equipment (EGD1-EGD3) each associated with locations (L1-L3) and each tasked with checking the storage of digital images of objects which are located in the associated locations matched with information representative of the distributed management equipment (EGD1-EGD3) which respectively store them, of their availability status, of the rules defining their usage, of the accessibility status of the corresponding objects, and of rules defining the usage of the corresponding object, and secondly, with generating requests for access to at least one object or object image in their associated locations, and ii) a centralized management equipment (EGG) tasked, whenever it receives a request from a distributed management equipment (EGD1) for access to the given object or object image in the location (L1) with which it is associated, with accessing the information which is associated with that given object or object image in order to allow it to be accessed in a designated location (L1) when its accessibility or availability status allows this in that given location (L1) and if the request complies with the associated usage rules.

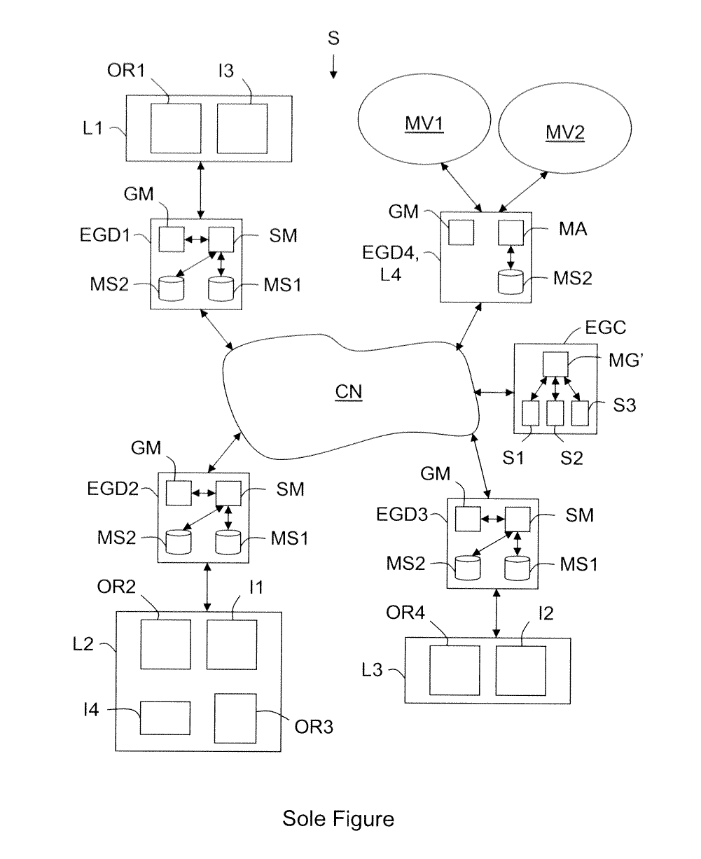

The invention pertains to the field of accessibility to real or virtual objects.

All types of objects are concerned by the invention, and particularly artworks, books, and products, plants, equipment, or items sold in stores or shops.

Whenever one is in a location in which objects of a given type may be exhibited and/or sold, it frequently occurs that some of these objects are not present. For example, a person may wish to observe the works of a painter which are normally exhibited in a museum or gallery, but when he or she goes to that museum or gallery, he or she notices that one or more works are momentarily absent, for example because they have been loaned out or are being restored. In another example, a person may wish to see models of a given brand of shoes which is normally sold in a given store, though when he or she goes to that store, he or she notices that one or more models (or one or more colors of one model) of that given brand are not being sold there.

Generally, it is often difficult, or even impossible, to gather in any given location at a given time all objects which form part of a collection or set.

Several solutions, known as “augmented reality”, have been proposed to make it possible to merge real and virtual worlds.

This is particularly true of the solution proposed in the patent WO 27: 03/060830, which is directed at displaying visible and invisible risks (or dangers) in combination with information about them. The drawback of this solution resides in the fact that it is not suitable for sharing and gathering real and virtual objects which are distributed across different locations, and that it does not take into consideration any of the objects' usage rights (specifically DRM (“Digital Right Management”)).

This is also true of the solution described in Schmalsteig et al., “Managing complex augmented reality models”, July/August 2007, IEEE Computer Graphics and Applications Journal, pages 32-41. This solution more specifically proposes a centralized database in which models are stored in augmented reality. However, this type of centralized database is not well-suited to situations (the most frequent ones) in which multiple stakeholders in different locations need to share and assemble models in augmented reality in real time. This unsuitability particularly results from capacity and performance problems encountered by these centralized databases and the communication networks to which they are connected, and from the data transmission lags which are introduced.

The purpose of the invention is therefore to improve the situation.

To that end, it proposes a method devoted to managing the accessibility of objects in different locations, and consisting of:
generating and storing digital images of these objects,
associating each digital image with information representative of the location in which it is stored, of its availability status, of rules defining its usage, of the location where a corresponding object is located, of the accessibility status of the corresponding object, and of rules defining the usage of the corresponding object, and
authorizing access, in a given location, to at least one object and/or one image when its accessibility or availability status allows this in that given location and if the associated usage rules are complied with.

The invention also proposes a system, devoted to managing the accessibility of objects in different locations, and comprising:
distributed management equipment each associated with locations, coupled with a communication network and each tasked firstly with checking the storage of digital images of objects which are located in their associated locations matched with information representative of the distributed management equipment which respectively store them, of their availability status, of the rules defining their usage, of the accessibility so status of the corresponding objects, and of rules defining the usage of the corresponding object, and secondly, with generating requests for access to at least one object or object image in their associated location, and
a centralized management equipment coupled to the communication network and tasked, whenever it receives a request from a distributed management equipment for access to the given object or object image in the location with which it is associated, with accessing the information which is associated with that given object or object image in order to allow it to be accessed in a designated location when its accessibility or availability status allows this in that given location and if the request complies with the associated usage rules.

The inventive system may comprise other characteristics, which may be taken separately or in combination, in particular:
at least some of the distributed management equipment may comprise first storage means capable of storing the digital images of objects which are located in the location which is associated with them, matched with the associated information;
at least some of the distributed management equipment may comprise a second storage means capable of storing the digital object images which are located in locations which are not associated with them and for which they have obtained access authorization;
at least some of the distributed management equipment may comprise management means tasked with checking the storage, within their first storage means, of the digital images of the objects which are located in their location matched up with the associated information, and with generating requests for access to at least one object or object image within their associated location, and/or storing within their second storage means the digital object images which are located in locations which are not associated with them and for which they have obtained access authorization;
at least one of the distributed management equipment may be associated with at least one virtual world and may comprise adaptation means tasked with enabling interoperability with that virtual world;
the centralized management equipment may be capable of storing information which is associated with the object images;
   the centralized management equipment may comprise a first server capable of storing information which is associated with the object images and representative of their availability status and of the respective accessibility statuses of the corresponding object;
   the centralized management equipment may comprise a second server capable of storing the information which is associated with the object images and representative of the distributed management equipment which respectively store them, and of the locations where the corresponding objects are respectively located;
   the centralized management equipment may comprise a third server capable of storing information which is associated with the object images and representative of rules defining their usage and rules defining their respective usage of the corresponding objects;
   the centralized management equipment may comprise management means tasked with supplying information to the first server and/or the second server and/or the third server, and, if a request is received from a distributed management equipment for access to a given object or object image within the location with which it is associated, with accessing the information which is associated with that given object or object image and stored within the first server and/or the second server and/or the third server, in order to allow it to be accessed in a designated location when its accessibility or availability status allows this in that given location and if the request complies with the associated usage rules;
      the management means may be tasked with notifying at least some of the distributed management equipment if a new object located in a location different from their associated location, or a new object image stored in another distributed management equipment, is detected.

Other characteristics and advantages of the invention will become apparent upon examining the detailed description below, and the attached drawings, in which the sole FIGURE schematically and functionally depicts an example of the inventive accessibility management system. The drawing may serve not only to complete the invention, but also to contribute to defining it, if need be.

The purpose of the invention is to propose an accessibility management method, and associated system, making it possible to gather and share, in a controlled fashion, real and virtual objects in different locations. The notion of accessibility here includes the notions of sharing, availability, and presence.

As depicted in the sole FIGURE, the implementation of the invention requires the existence of locations Li in which are stored objects which are real ORj or virtual.

Here, the word “location” refers to a place where objects of at least one type may be exhibited and/or sold. They may therefore, for example, be exhibition locations or sites, such as museums or galleries, or stores, boutiques, or shops, or websites (or similar sites). A location may therefore be a real or virtual site (a website or virtual world, for example)

In the sole FIGURE, four sites L1 to L4 (i=1 to 4) have been depicted. However, the invention applies as soon as there are at least two different locations Li.

Furthermore, here the word “object” refers to anything that may be exhibited and/or sold in a location Li. They may therefore, for example, be artworks (such as paintings, engravings, sculptors, lithographs, photographs, or woven, glass, porcelain, or earthen pieces), books, or products or plants or equipment or items.

The inventive management method comprises three main steps.

A first main step consists of generating and storing digital images Ij of the objects ORj which are located in each of the concerned locations Li. It should be noted that the objects ORj of which a digital image Ij is taken are preferentially real. However, they may also be virtual objects designed using computers.

In what follows, it is assumed that the locations L1 to L3 are three museums in which artists' works, such as paintings, are being exhibited. The objects of which a digital image is taken are therefore real (ORj). The fourth location L4, also depicted in the sole FIGURE, is a website which makes it possible to access images Ik of real or virtual objects.

A second main step of the inventive method consists of associating each digitized image Ij with information that is representative:
of the location where it is stored,
of its availability status (available, unavailable, temporarily available, temporarily unavailable, and likewise),
of rules which define its use, such as copyrights (or DRM), the sharing policy, conditions of use and/or exhibition, safety rules, dealing terms, and likewise,
of the location Li where the corresponding real ORj or virtual object is located,
of the accessibility status of the corresponding real ORj or virtual objects (available, unavailable, temporarily available, temporarily unavailable, being restored, and likewise), and
of rules which define the use of the corresponding real ORj or virtual object, such as copyright (or DRM), the sharing policy, conditions of use and/or exhibition, safety rules, dealing terms, and likewise.

A third main step of the inventive method consists of allowing access within a given location Li to at least one object ORj and/or one object image Ij when its accessibility or availability status allows this in that given location Li and if the associated rules of usage are complied with.

In order to implement the aforementioned method, the invention proposes an accessibility management system S which is, for example, of the type that is depicted in the sole FIGURE.

A system S according to the invention comprises at least two distributed management equipments EGDi and one centralized management equipment EGC.

Each distributed management equipment EGDi is associated with a location Li and coupled with a communication network RC (wired or not wired).

The centralized management equipment EGC is also coupled to the communication network RC. It should be noted that it may, for example, form part of an IMS core network.

It is important to note that the distributed management equipment EGDi and the centralized management equipment EGC may be connected to (or form part of) different communication networks, provided that these communication networks are coupled (or connected) to one another.

Each distributed management equipment EGDi is tasked with checking the storage of digital images Ij of the real ORj or virtual objects, which are located in a location Li with which it is associated, matching with at least one piece of the aforementioned information.

To do so, it comprises, for example, a management module MG which may be assisted by a modeling module MM.

The management module MG constitutes a sort of interface with the rest of the system S, and particularly with the centralized management equipment EGC and with any object image display equipment which are present at the associated location Li. In locations Li (i=1 to 3) such as museums (or shops), the display equipment may, for example, be flat-screens fastened onto walls or computer screens capable of displaying at least one object image Ij or augmented reality equipment, such as glasses.

The management module MG is preferentially tasked with associating the aforementioned information to the images Ij of the objects ORj which are located in the location Li with which it is associated.

The modeling module MM is, for example, tasked with placing into a chosen format the digital images Ij which are, for example, provided by a communication device of the associated location Li, such as a computer supplied with image data by a digital camera. It may also potentially be configured so as to enable the creation of virtual objects, then to store them in the form of digital images in a chosen format.

It should be noted that the digital image Ij of an object ORj may be two-dimensional (2D) or three-dimensional (3D). Furthermore, the digital image Ij of an object ORj, which is stored, may be a two-dimensional (2D) or three-dimensional (3D) model of that object ORj which results from image processing, which may for example be carried out by means of the modeling module MM. In other words, a digital image Ij according to the invention may be either a digital photograph of an object, or representative of that object.

Preferentially, and as depicted in a nonlimiting fashion, at least some of the distributed management equipment EGDi (here EGD1 to EGD3) comprise first storage means MS1 which are tasked with storing the digital images Ij of objects which are located in a location Li which is associated with them, matching with the associated information.

These first storage means MS1 may come in any form known to the person skilled in the art, provided that they may store files containing digital data representing object images Ij. Consequently, they may, for example, be a memory or database.

Each distributed management equipment EGDi is also tasked with generating requests to the centralized management equipment EGC for access to at least one real ORj or virtual object or object image Ij in the location Li with which it is associated. These requests may, for example, be generated by the management module MG based on instructions provided locally by an authorized person.

It should be understood that a request, which is issued by a distributed management equipment EGDi associated with a location Li, must particularly designate a real ORj or virtual object which is located in another remote location Li′ (i′≠i) or an object image Ij which is stored within a distributed management equipment EGDi′ associated with another location Li′ and that it is made accessible (meaning exhibited (potentially by digital display)) in the location Li. This request also contains the definitions of the conditions under which the object ORj or image Ij is desired to be used in the location Li.

In order for the distributed management equipment EGDi to be able to generate requests, they must have a list of objects ORj and object images Ij and their respective identifiers. This list is, for example, stored in the centralized management equipment EGC. It may be obtained by a distributed management equipment EGDi on request or it may be transmitted automatically to the distributed management equipment EGDi periodically or every time that it is updated subsequent to an object ORj or at least one so object image Ij being added or removed.

It should be noted, as illustrated in a nonlimiting fashion, and that at least some of the distributed management equipment EGDi (here EGD1 to EGD4) may comprise a second storage means MS2 which are tasked with storing the digital images Ij of the real ORj or virtual objects which are located in locations Li′ which are not associated with them and for which they have obtained access authorization (and therefore local distribution) from the centralized management equipment EGG.

These second storage means MS2 may come in any form known to the person skilled in the art, provided that they may store files containing digital data representing object images Ij. Consequently, they may, for example, be a memory or database.

It should be noted that the first MS1 and second MS2 storage means of a distributed management equipment EGDi (i=1 to 3) may potentially be two parts of the same storage means.

It also be noted, as depicted in a nonlimiting fashion, that at least one of the distributed management equipments (here EGD4) may be exclusively dedicated to managing the accessibility of object images Ij, because it is associated with at least one virtual world MV1, MV2, such as Second Life. As a reminder, this distributed management equipment EGD4 may, for example, be associated with a website L4.

It may, for example, comprise, in addition to its management module MG, second storage means MS2 in which it stores all the digital images Ij of the real ORj or virtual objects which are located in locations Li′ (i′≠4) which are not associated with said and for which it has obtained access authorization and therefore usage authorization, for at least some of the clients of its associated website, from the centralized management equipment EGC.

As depicted, this distributed management equipment EGD4 may also potentially comprise an adaptation module MA tasked with ensuring interoperability with the virtual world(s) MV1 and MV2. Interoperability here should be taken in the most general sense. In particular, it refers to the formats of the object images Ij, access and interactivity between different worlds (real or virtual), and synchronization. This interoperability may particularly be provided by the adaptation module MA based on predefined rules.

It should be noted that each distributed management equipment EGDi, and particularly its management module MG and any storage means MS1 and/or MS2 and/or adaptation module MA it may have, may be constructed in the form of electronic circuits, software (or computer) modules, or a combination of electronic circuits and software modules.

The centralized management equipment EGC particularly intervenes every time it receives from a distributed management equipment EGDi (i=1 to 4) a request for access within the location Li, with which that equipment (EDGi) is associated, to a real ORj or virtual object which is located in another remote location Li′ (i′≠i) or an object image Ij which is stored in a distributed is management equipment EGDi′ associated with another location Li′.

This intervention first consists of accessing the information which is associated with the object ORj or with the object image Ij which is designated within the received request, then analyzing this information, particularly by comparing them to the conditions of use which are defined in the received request. If the accessibility or availability status of that object ORj or that designated object image Ij allows this, and the conditions of use which are defined within the received request comply with the usage rules which are associated with it, then the centralized management equipment EGC allows access to that object ORj or object image Ij within the location Li (which is also designated within the received request).

As depicted in a non-limiting fashion in the sole FIGURE, the centralized management equipment EGC may comprise a management module MG′ tasked with processing the received requests, and more specifically, at least with accessing the information which is associated with the objects ORj and object images Ij designated within the requests, and sending access authorization or prohibition messages to the distributed management equipment EGDi which sent the requests.

It should be noted that an access authorization message may potentially contain definitions of conditions of use (potentially broader or more limited than those requested).

The management module MG′ constitutes a sort of interface with the rest of the system S, and particularly with the distributed management equipment EGDi.

Preferentially, the centralized management equipment EGC stores all the information which is associated with the object images Ij which are stored within the distributed management equipment EGDi associated with the various locations Li. However, in one variant (currently not preferred for reasons of response time and/or traffic) it may be conceived that its management module MG′ be tasked with accessing information which is stored within the distributed management equipment EGDi (for example, within their respective first storage means MS1) in order to make its access authorization or prohibition decisions.

Centralized information storage may be carried out within a single element or, as depicted in a nonlimiting fashion, within at least two elements S1 to S3. In the illustrated example, the centralized management equipment EGC comprises first S1, second S2 and third S3 elements, for example, a server, devoted at least two storing information associated with object images lj. It should be understood that the information which is associated with the object images Ij, which are stored within distributed management equipment EGDi, are transmitted to the centralized management equipment EGC by the distributed management equipment EGDi.

The first server S1 is, for example, tasked with storing the information which is associated with the object images Ij and representative of their respective availability statuses and the respective accessibility statuses of the corresponding real ORj or virtual objects. It is queried by the management module MG′ subsequent to the receiving of a request in order to communicate to it the status of each object ORj or image Ij which is designated within that request. It somewhat constitutes a presence server (or status server).

The second server S2 is, for example, tasked with storing information which is associated with the object images Ij and representative of the distributed management equipment EGDi which respectively stores them and locations Li where the corresponding real ORj or virtual objects are respectively located. It is queried by the management module MG′ subsequent to receiving a request in order to communicate to it the identifier of each location Li where each object ORj designated within that request or identifier of each distributed management equipment EGDi which stores each image Ij which is designated within that request. It somewhat constitutes a location server.

The third server S3 is, for example, tasked with storing the information which is associated with the object images Ij and representative of the rules which define their respective uses and the rules which define the respective uses of the corresponding real ORj or virtual objects. It is queried by the management module MG′ subsequent to receiving a request in order to communicate to it the usage rules of an object ORj or an image Ij designated within that request or to report to it whether the conditions of use which are defined in that request complying with the usage rules each object ORj or image Ij designated within that request (if it is configured to make comparisons). It somewhat constitutes a rights sharing and management (or even negotiation) server.

It is important to note that the servers S1 to S3 store the information associated with the object images Ij, but not the files which contain the data defining these object images Ij. These image files are preferentially stored in distributed management equipment EGDi which are associated with the locations Li where the corresponding objects ORj are stored.

It should also be noted that the management module MG′ may) potentially be tasked with generating, for at least some of the distributed management equipment EGDi, messages intended to notify them whenever it has detected the presence of a new real ORj or virtual object located in a location Li′ different from the location Li which is associated with them or the storage of a new object image Ij within another distributed management equipment EGDi.

If access authorization is granted to an object image Ij (or to a virtual object), the centralized management equipment EGC may itself extract a copy of that object image's file lj from the distributed management equipment EGDi which stores that, then transmit that file to the distributed management equipment EGDi′ which requested it, or to provide the distributed management equipment EGDi which is storing the file of that object image Ij and the distributed management equipment EGDi′ which requested that file their respective coordinates so that they can transfer the file themselves.

If loan authorization is granted for a real object ORj, the centralized management equipment EGC may for example provide the distributed management equipment EGDi which is associated with a location Li where that object is located ORj and with the distributed management equipment EGD1′ which requested that object ORj their respective coordinates so that their respective managers can organize between themselves the object's transfer ORj from the location Li to the other location Li′ (associated with the distributed management equipment EGDi′ which requested it).

It should also be noted that the centralized management equipment EGC, and particularly its management module MG′ and any servers S1 to S3, may be constructed in the form of electronic circuits, software (or computer) modules, or a combination of electronic circuits and software modules.

We will now describe an example use of the inventive system S with reference to the sole FIGURE.

In this example, it is assumed that:
the first museum L1 normally comprises two paintings OR1 and OR3, and therefore the associated distributed management equipment EGD1 stores the images I1 and I3 of these two paintings OR1 and OR3,
the second museum L2 normally comprises one painting OR2, and therefore the associated distributed management equipment EGD2 stores the image I2 of that painting OR2, and
the third museum L3 normally comprises one painting OR4, and therefore the associated distributed management equipment EGD3 stores the image I3 of that painting OR4.

As the curator of the second museum (second location) L2 wishes to organize an exhibit that will include paintings OR1 to OR4, he transmits to the centralized management equipment EGC, by means of the distributed management equipment EGD2, a request to temporarily loan the paintings OR1, OR3 and OR4 according to given conditions of use.

When this request is received, the centralized management equipment EGC determines whether the paintings OR1, OR3 and OR4 may be loaned out under the conditions of use specified in the request, given their respective usage rules. Here, it is assumed that the painting OR3 may be loaned out to the second museum L2, that the image I1 of the painting OR1 may be used by the second museum L2 for a wall display, and that the image I4 of the painting OR4 may be used by the second museum L2 for a wall display in exchange for the use of the image I2 of the painting OR2 by the third museum L3.

In the end, the situation depicted in the sole FIGURE is achieved. More specifically:
the first museum L1 has loaned out its painting OR3 and the image 11 of the painting OR1 to the second museum L2, and therefore now includes only the painting OR1 and the image I3 of the painting OR3 which it is displaying on a wall screen,
the second museum L2 has received on loan the painting OR3 and the image I1 of the painting OR1 from the first museum L1 and the image I4 of the painting OR4 from the third museum L3. It therefore exhibits on its walls the paintings OR2 and OR3 and displays on the wall screens the images I1 and I4 of the paintings OR1 and OR4, and
the third museum L3 has loaned out the image I4 of the painting OR4 to the second museum L2 in exchange for these of the image I2 of its painting OR2. It therefore comprises the painting OR4 and the image I2 of the painting OR2 which it displays on a wall screen.

The invention is not limited to the embodiments of the accessibility management system and method and a centralized and distributed management equipment described above, which are given only as an example, but rather encompasses all the variants that the person skilled in the art may envision within the scope of the claims below

1. A method devoted to managing the accessibility of objects in different locations (Li), and consisting of i) generating and storing the digital images of said objects, ii) associating each image with information representative of the location where it is stored, its availability status, and rules defining its use, of the location (Li) where the corresponding object is located, of the accessibility status of the corresponding object, and rules defining the usage of the corresponding object, and iii) authorizing access, in a given location (Li), to at least one object and/or one image when its accessibility or availability status allows this in that given location and if the associated usage rules are complied with.

2. A system (S) for managing accessibility to objects in different locations (Li), wherein it comprises i) distributed management equipment (EGDi) each associated with locations (Li), coupled with a communication network (RC) and each tasked firstly with checking the storage of digital images of objects which are located in their associated locations (Li) matched with information representative of the distributed management equipment (EGDi) which respectively store them, of their availability status, of the rules defining their usage, of the accessibility status of the corresponding objects, and of rules defining the usage of the corresponding object, and secondly, with generating requests for access to at least one object or object image in their associated locations (Li), and ii) a centralized management equipment (EGC) coupled to the communication network (RC) and tasked, whenever it receives a request from a distributed management equipment (EGDi) for access to the given object or object image in the location (Li) with which it is associated, with accessing the information which is associated with that given object or object image in order to allow it to be accessed in a designated location (Li) when its accessibility or availability status allows this in that given location (Li) and if the request complies with the associated usage rules.

3. A system according to claim 2, wherein at least some of said distributed management equipment (EGDi) comprise first storage means (MS1) capable of storing the digital images of objects which are located in the location (Li) which is associated with them, matched with the associated information.

4. A system according to claim 2, wherein at least some of the distributed management equipment (EGDi) comprise second storage means (MS2) capable of storing the digital object images which are located in locations (Li′) which are not associated with them and for which they have obtained access authorization;

5. A system according to claim 3, wherein at least some of at least some of the distributed management equipment (EGDi) comprises management means (MG) tasked with checking the storage, within their first storage means (MS1), of the digital images of the objects which are located in their location (Li) matched up with the associated information, and with generating requests for access to at least one object or object image within their associated location (Li), and/or storing within their second storage means (MS2) the digital object images which are located in locations (Li′) which are not associated with them and for which they have obtained access authorization.

6. A system according to claim 2, wherein at least one of said distributed management equipment (EGDi) is associated with at least one virtual world and comprises adaptation means (MA) configured to enable interoperability with said virtual world.

7. A system according to claim 2, wherein said centralized management equipment (EGC) is capable of storing said information which is associated with said object images.

8. A system according to claim 7, wherein said centralized management equipment (EGC) comprises a first server (S1) capable of storing said information which are associated with object images and representative of their availability status and the respective accessibility statuses of the corresponding objects.

9. A system according to claim 7, wherein said centralized management equipment (EGC) comprise a second server (S2) capable of storing the information which is associated with the object images and representative of the distributed management equipment (EGDi) which respectively store them, and of the locations (Li) where the corresponding objects are respectively located.

10. A system according to claim 7, wherein said centralized management equipment (EGO) comprise a third server (S3) capable of storing information which is associated with the object images and representative of rules defining their usage and rules defining their respective usage of the corresponding objects.

11. A system according to claim 7, that wherein said centralized management equipment (EGC) comprises management means (MG′) tasked with supplying information to the first server (S1) and/or the second server (S2) and/or the third server (S3), and, if a request is received from a distributed management equipment (EGDi) for access to a given object or object image within the location (Li) with which it is associated, with accessing the information which is associated with that given object or object image and stored within the first server (Si) and/or the second server (S2) and/or the third server (S3), in order to allow it to be accessed in a designated location (Li) when its accessibility or availability status allows this in that given location (Li) and if the request complies with the associated usage rules.

12. A system according to claim 11, wherein said management means (MG′) may be tasked with notifying at least some of the distributed management equipment (EGDi) if a new object located in a location (Li′) different from their associated location (Li), or a new object image stored in another distributed management equipment (EGDi′), is detected.
